(19) United States
(12) Patent Application Publication
(10) Pub. No.: US 2021/0061623 A1
(43) Pub. Date: Mar. 4, 2021

(54) MULTI-DIRECTIONAL LOAD ISOLATING MECHANICAL FUSE

(71) Applicant: Loon LLC, Mountain View, CA (US)

(72) Inventor: Mathew Tabor, San Francisco, CA (US)

(21) Appl. No.: 16/553,501

(22) Filed: Aug. 28, 2019

(51) Int. Cl. B66C 15/00

(52) U.S. Cl. CPC B66C 15/00

(57) ABSTRACT

Aspects of the disclosure relate to a mechanical fuse. The mechanical fuse may include a top portion having a first shear pin configured to break when a predetermined side load is applied to the mechanical fuse. The mechanical fuse may also include a bottom portion having a second shear pin, wherein the second shear pin is configured to break when a predetermined vertical load is applied to the mechanical fuse. Wherein the mechanical fuse may be arranged such that when the second shear pin is broken under the predetermined vertical load, the first shear pin also breaks before the bottom portion separates from the top portion, and when the first shear pin is broken under the predetermined side load, the second shear pin remains intact when the bottom portion separates from the top portion.

### BACKGROUND

Various when moving mechanisms such as cranes are lifting objects, the objects may apply both side forces as well has vertical forces (in the direction of gravity). Typically cranes have specific load ratings and are much stronger in the vertical direction than the side or lateral direction. In order to protect the boom structure of the crane, a mechanical fuse designed to fail at precise conditions may be used to relieve loading on the crane's overall structure.

### BRIEF SUMMARY

Aspects of the present disclosure provide a system comprising a mechanical fuse. The mechanical fuse includes a top portion having a first shear pin configured to break when a predetermined side load is applied to the mechanical fuse. The mechanical fuse also includes a bottom portion having a second shear pin. The second shear pin is configured to break when a predetermined vertical load is applied to the mechanical fuse. The mechanical fuse is arranged such that when the second shear pin is broken under the predetermined vertical load, the first shear pin also breaks before the bottom portion separates from the top portion. When the first shear pin is broken under the predetermined side load, the second shear pin remains intact when the bottom portion separates from the top portion.

In one example, the bottom portion is configured for attachment with lifting equipment. In addition, the system also includes the lifting equipment. In another example, the top portion includes a protrusion having a groove therein configured to engage with a shear hub of the bottom portion. In this example, the second shear pin is at least partially arranged within the shear hub. In addition, the shear hub is able to freely rotate around the second shear pin. In addition or alternatively, when the bottom portion is engaged with the top portion and a side load is applied to the mechanical fuse, the side load causes the shear hub to rotate around the second shear pin. In this example, the bottom portion further includes a drum having an opening therein and the second shear pin is at least partially arranged within the opening of the drum. In addition, when a vertical load is applied to the mechanical fuse, the drum and the shear hub each impart forces on the second shear pin in different directions. In this example, the top portion further includes a bearing arranged below the protrusion, and when a vertical load is applied to the mechanical fuse, the bearing applies a force against the shear hub and the second shear pin. In some examples, the top portion further includes a bearing arranged below the protrusion, and wherein when the bottom portion is engaged with the top portion, the shear hub is arranged between the protrusion and the bearing. In this example, the shear hub includes a rounded portion and a portion opposite the rounded portion, and when the bottom portion is engaged with the top portion, the rounded portion is arranged to engage with the groove and the portion opposite of the rounded portion is arranged to engage with the bearing. In another example, the top portion further includes a first threaded opening and a first groove in an outer edge of the top portion, and when the bottom portion is engaged with the top portion, the first groove is arranged to engage with a first bolt. In this example, the system also includes a first bolt and a second bolt arranged in the first threaded opening, and the bottom portion further includes a second threaded opening in which the first bolt is arranged and a second groove in an outer edge of the bottom portion, and wherein when the bottom portion is engaged with the top portion, the second groove is arranged to engage with the second bolt. In addition, the first bolt and the second bolt are arranged to limit bending of the mechanical fuse when the bottom portion is engaged with the top portion. In another example, the bottom portion includes an opening configured to receive the first shear pin. In this example, the opening includes one or more slots in order to reduce vertical loading on the first shear pin when the bottom portion is engaged with the top portion. In another example, when the bottom portion is engaged with the top portion the first shear pin is arranged in an opening of the bottom portion, and a side load is applied to the mechanical fuse, a side surface of the opening causes a lateral force on the first shear pin. In another example, the bottom portion is configured for attachment with a crane boom of a crane. In this example, the system also includes the crane.

### BRIEF DESCRIPTION OF THE DRAWINGS

FIG. 1 includes an example system including a lifting mechanism, a mechanical fuse, lifting equipment and an object in accordance with aspects of the disclosure.

FIG. 2 is an example perspective view of a mechanical fuse in accordance with aspects of the disclosure.

FIG. 3 is a view of a top portion of a mechanical fuse in accordance with aspects of the disclosure.

FIG. 4 is a view of a top portion of a mechanical fuse in accordance with aspects of the disclosure.

FIG. 5 is a partially transparent view of a mechanical fuse in accordance with aspects of the disclosure.

FIG. 6 is a partially transparent view of a mechanical fuse in accordance with aspects of the disclosure.

FIG. 7 is a partially transparent view of a mechanical fuse in accordance with aspects of the disclosure.

FIG. 8 is a partially transparent view of a mechanical fuse in accordance with aspects of the disclosure.

FIG. 9 is a partially transparent view of a mechanical fuse in accordance with aspects of the disclosure.

FIG. 10 is a partially transparent view of a mechanical fuse in accordance with aspects of the disclosure.

FIG. 11 is a partially transparent view of a mechanical fuse in accordance with aspects of the disclosure.

FIG. 12 is a partially transparent view of a mechanical fuse in accordance with aspects of the disclosure.

FIG. 13 is a detail view of aspects of a mechanical fuse in accordance with aspects of the disclosure.

### DETAILED DESCRIPTION

The technology relates to a load-bearing mechanical fuse that is capable of breaking at different load values for lateral or side and vertical loads. For instance, when moving mechanisms such as cranes are lifting objects, the objects may apply both side forces as well has vertical forces (in the direction of gravity). Typically cranes have specific load ratings and are much stronger in the vertical direction than the side or lateral direction. In order to protect the boom structure of the crane, a mechanical fuse designed to fail at precise conditions may be used to relieve loading on the crane's overall structure. However, these fuses do not necessarily provide both lateral and vertical protection while isolating lateral from vertical forces. The mechanical fuse described herein can be configured to break under different loads applied in different directions on the fuse. Thus, the mechanical fuse may separate side loading from vertical loading and may be utilized in any number of different applications where different forces may be expected in different directions.

The mechanical fuse includes two portions; a top portion and a bottom portion. The top portion may be configured for connection to a moving mechanism. The top portion may include a protrusion having a groove therein configured to engage with a shear hub including a second shear pin of the bottom portion as well as a round bearing arranged below the protrusion. The top portion may also include a threaded opening for receiving a first bolt and bottom edge of the top portion includes a groove for engaging with a second bolt arranged in the bottom portion.

The top portion may include a first shear pin configured to engage with an opening in the bottom portion. The first shear pin may be arranged to feel a side shear force as the crane boom is loaded laterally. The first shear pin may be configured in order to break under a desired amount of lateral force.

The bottom portion may be configured for attachment to lifting equipment. The bottom portion includes an opening for receiving the first shear pin. This opening may be slotted in order to limit the amount of vertical loading on the first shear pin. The bottom portion also includes a threaded opening for receiving the second bolt and a top edge of the top portion includes a groove for engaging with the first bolt arranged in the top portion.

The bottom portion may also include the second shear pin. The second shear pin may be partially arranged within an opening of the bottom portion. When the top and bottom portions are engaged with one another, the second shear pin and shear hub may be arranged such that the rounded portion engages with the groove of the protrusion and the pointed portion engages with the bearing. The second shear pin may be configured in order to break under a desired amount of vertical force.

During operation, as the mechanical fuse is side loaded, the bottom portion may rotate relative to the top portion, causing a side surface of the opening in the bottom portion to apply a lateral force on the first shear pin. At the same time, the shear hub and/or the second shear pin may be able to freely rotate such that the second shear pin does not “feel” the side loading. Once a certain side load is applied, the first shear pin may break. This may cause the shear hub to slide over the bearing, and eventually, the bottom portion to separate from the top portion. In this regard, the second shear pin may not actually break when the fuse breaks due to side loading.

As the mechanical fuse is loaded vertically, the bottom portion may be pulled downward relative to the top portion. This, in turn, may cause the shear hub and drum to pull downward on the second shear pin. The shear hub may be pulled down against the bearing which provides a resistance force against the further downward movement of the shear hub. At a certain vertical load, the combination of the downward force of the drum against the second shear pin and the resistance force of the bearing against the shear hub may cause the second shear pin to break. At this point, the vertical forces may be translated to the first shear pin which may break as well. This may cause the bottom portion to separate from the top portion.

The mechanical fuse thus uses two independent shear pins for failure in either the vertical or horizontal axis (or in both). If either pin breaks, the top and bottom portions will separate entirely, leaving the bottom portion (connected to the lifting equipment) to fall away, ensuring the protection of the crane boom and upstream equipment by unloading the entire crane system.

The mechanical fuse described herein may be utilized in various types lifting or pulling equipment, for instance for construction, building, ballooning, or other industries which utilize cranes such as the oil and gas industries as well as heavy manufacturing. Almost all lifting cranes have a much lower side loading capacity and are not used when any side load can be imparted. This can often mean stopping work in wind or using complex rigging for non-standard shaped objects. However, this mechanical fuse may be used upstream of the lifted product to protect the crane or lifting device from any type of loading, side load and vertical load, reducing the likelihood of stopping work or complex rigging.

Aspects, features and advantages of the disclosure will be appreciated when considered with reference to the foregoing description of embodiments and accompanying figures. The same reference numbers in different drawings may identify the same or similar elements. Furthermore, the following description is not limiting; the scope of the present technology is defined by the appended claims and equivalents.

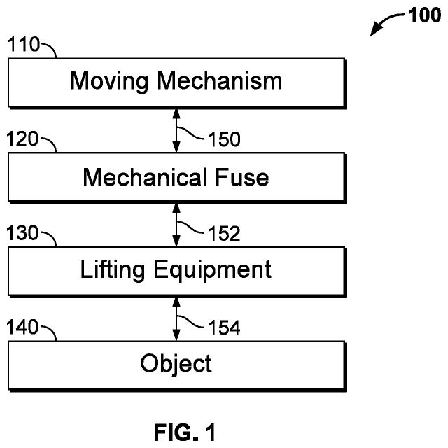

FIG. 1 includes an example system 100 including a moving mechanism 110, connected to lifting equipment 130 which together can be used to lift (vertically), pull (horizontally), or otherwise move a load or object 140. A mechanical fuse 120 may be arranged between the moving mechanism 110 and the lifting equipment 130 as a safety mechanism which can break at different load values for lateral or side and vertical loads. The arrows 150, 152, 154 each represent mechanical connections between the moving mechanism 110 and the mechanical fuse 120, between the mechanical fuse 120 and the lifting equipment 130, and between the lifting equipment 130 and the object 140, respectively, as discussed in further detail below. This example should not be considered as limiting the scope of the disclosure or usefulness of the features described herein.

The moving mechanism 110 may include a tool (such as a handheld or larger device), a machine for towing (such as a car, truck, or train), or other device that can be used to move and release objects such as robotic arms, assembly machine parts, construction equipment, sorting machines, pick and place robots, various types of cranes, including gantry cranes and jib cranes, etc. As an example, moving mechanism may be a crane including a crane boom. The lifting equipment 130 may include any kind of equipment configured for attachment to an object such as a magnet, hooks, grabbing mechanisms or other such devices.

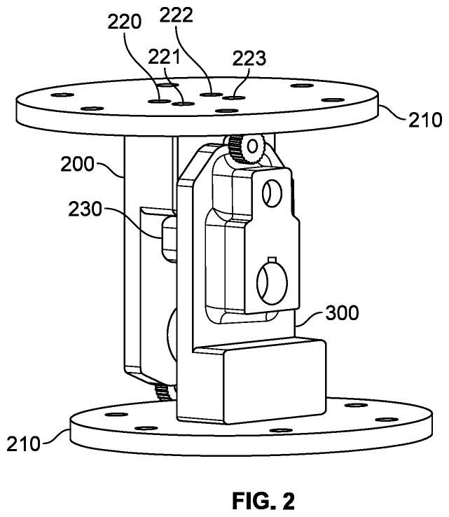

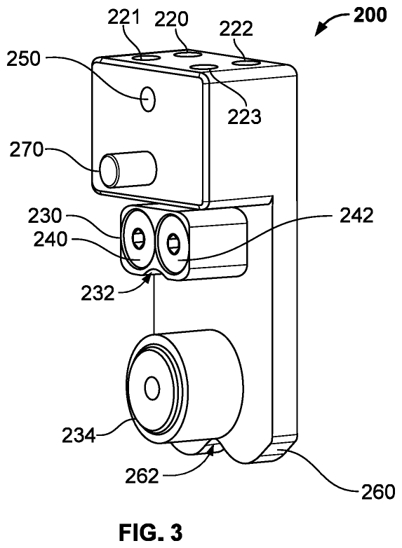

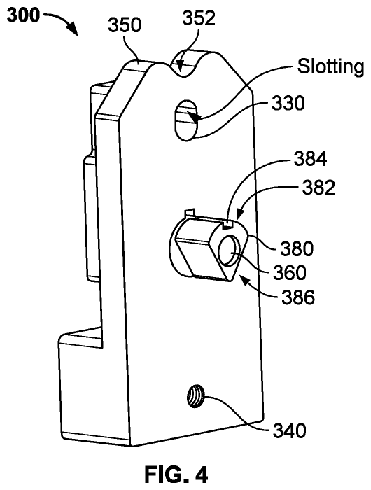

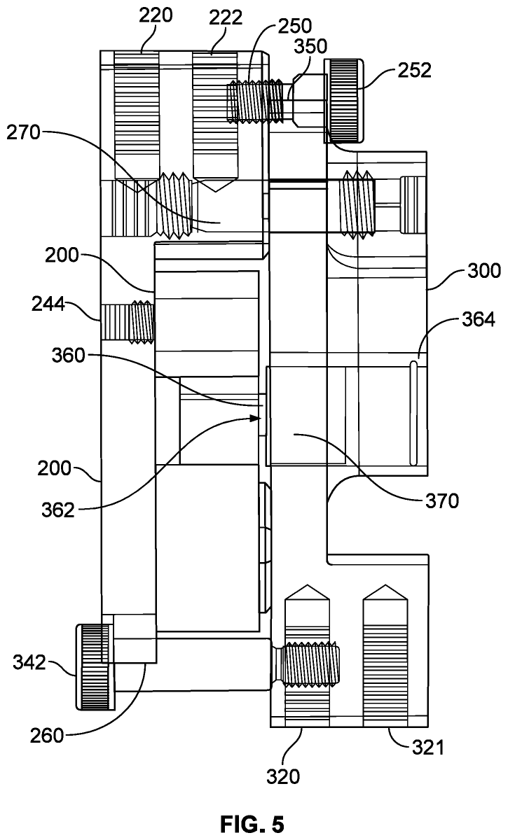

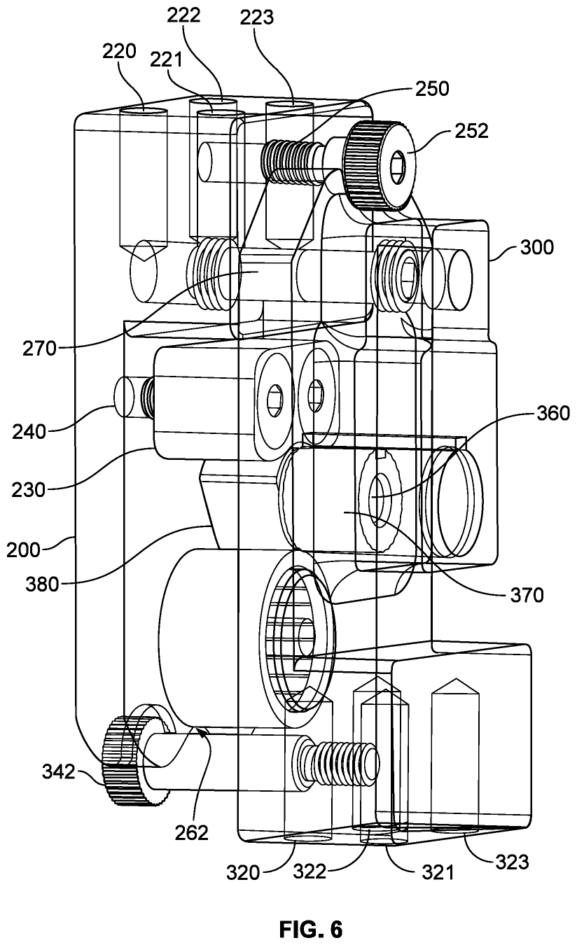

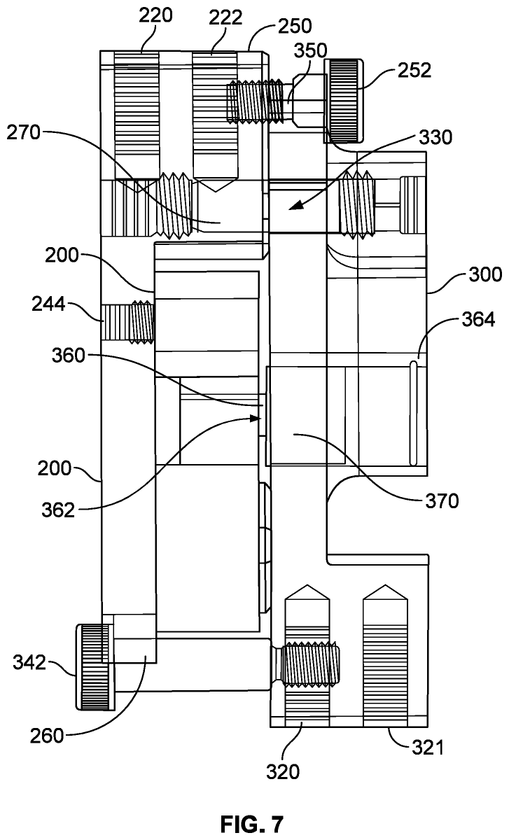

FIG. 2 is an example perspective view of the mechanical fuse 120, and FIGS. 5-8 are partially transparent views of the mechanical fuse 120. The mechanical fuse 120 includes two portions; a top portion 200 and a bottom portion 300. FIG. 3 is a perspective view of the top portion 200 and FIG. 4 is a perspective view of the bottom portion 300.

The top portion 200 may be configured for connection to a crane boom, for instance, via a mating disc 210 (shown in FIG. 2 only) using 2 or more bolts. The mating disc and top portion 200 include 4 holes 220-223 for receiving bolts (not shown) in order to connect to the crane boom of the moving mechanism 110.

The top portion 200 may also include a protrusion 230 having a groove 232 (FIG. 3) therein configured to engage with a shear hub 380 including a second shear pin 360 of the bottom portion 300 as well as a bearing 234 arranged below the protrusion 230. The protrusion may be secured to the top portion 200 via bolts 240, 242 engaged with threaded openings 244 (FIG. 5), 246 (not shown but arranged behind bolt 242). The protrusion 230 may act as an entrapment feature for the second shear pin 360 and may be made of brass, bronze or similar smooth metal or other “slippery” material to provide a sliding surface for the second shear pin 360. The top portion 200 also includes a threaded opening 250 for receiving a first bolt 252. An outer bottom edge 260 of the top portion 200 includes a groove 262 for engaging with a second bolt 342 arranged in the bottom portion 300. The first and/or second bolts may be “shoulder bolts”.

The top portion 200 also includes a first shear pin 270 configured to engage with an opening 330 in the bottom portion 300. The first shear pin 270 is arranged to feel a side shear force as the crane boom of the moving mechanism 110 is loaded laterally. The first shear pin 270 may be configured (size shape, surface configuration, materials, etc.) in order to break under a desired amount of lateral force. As such, the side failure load for the mechanical fuse 120 may be completely tune-able and can be changed easily for a variety of applications, and the first shear pin 270 may even be an “off the shelf” or commercially available shear pin. In addition, the distance between the two shear pins can be changed, for instance by drilling openings in different places, as another way to adjust the amount of force necessary to break the first shear pin. In other words, the distance between the first and second shear pins may dictate what force is felt in side loading by the first shear pin.

The bottom portion 300 may be configured for attachment to lifting equipment, for instance, via a mating disc 310 (shown in FIG. 2 only) using 2 or more bolts. The mating disc 310 and top portion 200 include 4 holes 320-323 for receiving bolts (not shown) in order to connect to the lifting equipment 130. As noted above, the bottom portion 300 includes an opening 330 for receiving the first shear pin 270. This opening 330 may be include one or more slots (slotting shown in FIG. 4) in order to limit the amount of vertical loading on the first shear pin 270. In other words, the slotting provides some additional degree of freedom in the vertical direction. The bottom portion 300 also includes a threaded opening 340 (FIG. 4) for receiving the second bolt 342. A top outer edge 350 of the bottom portion 300 includes a groove 352 for engaging with the first bolt 252 arranged in the top portion 200. When engaged with the respective top and bottom portions, these first and second bolts 252, 342 provide rigidity and limit or prevent bending of the mechanical fuse 120.

As noted above, the bottom portion 300 also includes the second shear pin 360. The second shear pin 360 may be partially arranged within an opening 362 of the bottom portion 300. In this example, the opening 362 is located within a drum 370, and one end of the second shear pin 360 is arranged within a shear hub 380. The second shear pin 360 may or may not be fixed within the drum 370 (i.e. may or may not be able to rotate freely within the drum), and shear hub 380 may be able to freely rotate around the second shear pin 360. The shear hub 380 may include a generally triangular shape with a rounded portion 382 having a groove 384 therein and a pointed portion 386 opposite of the rounded portion.

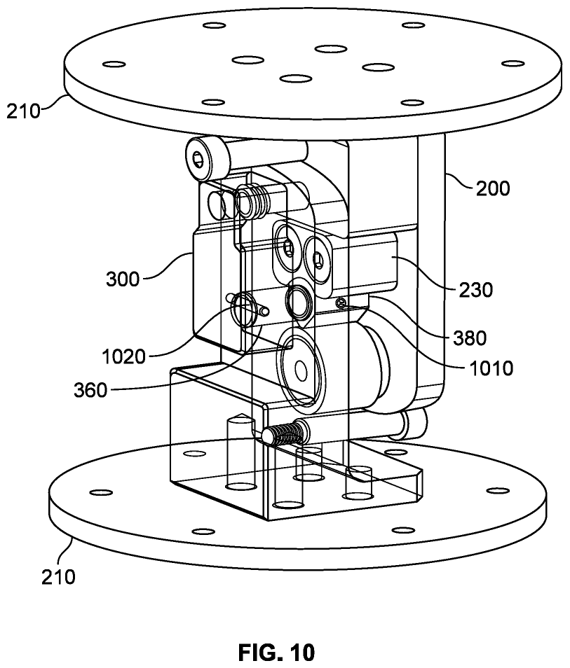

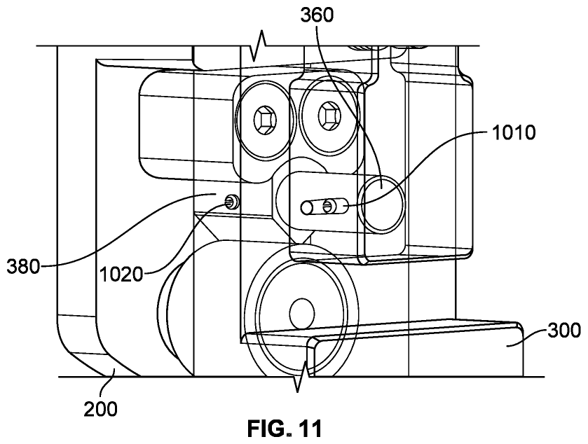

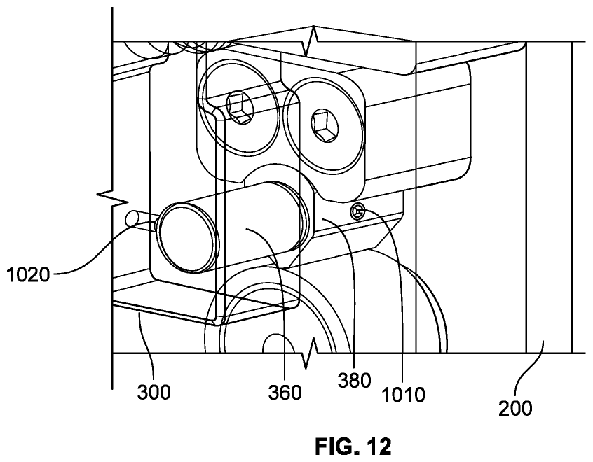

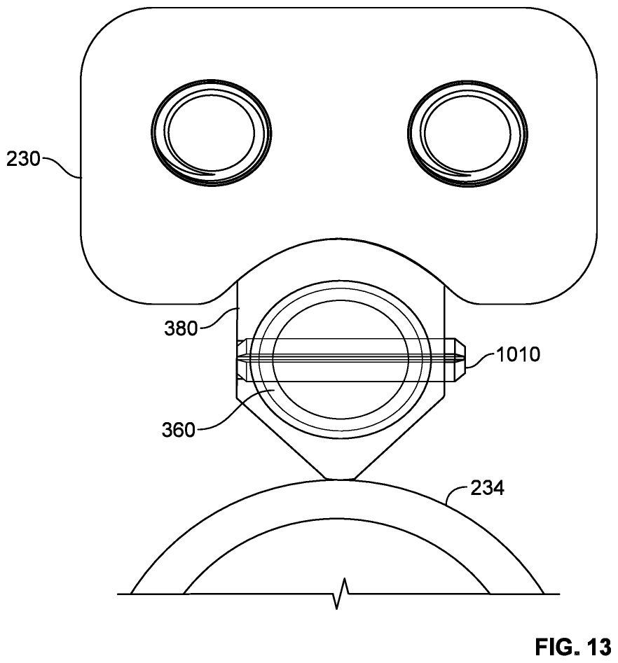

In some instances in order to stabilize the second shear pin 360, the bottom portion 300 may also include a slot 364 which may be aligned with the slot 384. A piece of metal or other material (not shown) may be placed through both of these slots in order to prevent the shear hub 380 from rotating. This may also prevent the second shear pin 360 from rotating. Alternatively, turning to the example of FIGS. 10-13, rather than using the aforementioned slots and a piece of material to stabilize the second shear pin, a first pin 1010 may be mounted through both the shear hub 380 and the second shear pin 360 (most readily understood with respect to FIG. 13) and a second pin 1020 may be mounted through the bottom portion 300 and the second shear pin 360. The first and second pins 1010, 1020 may limit or even prevent rotation of the second shear pin 360 with respect to shear hub 380 and the bottom portion 300.

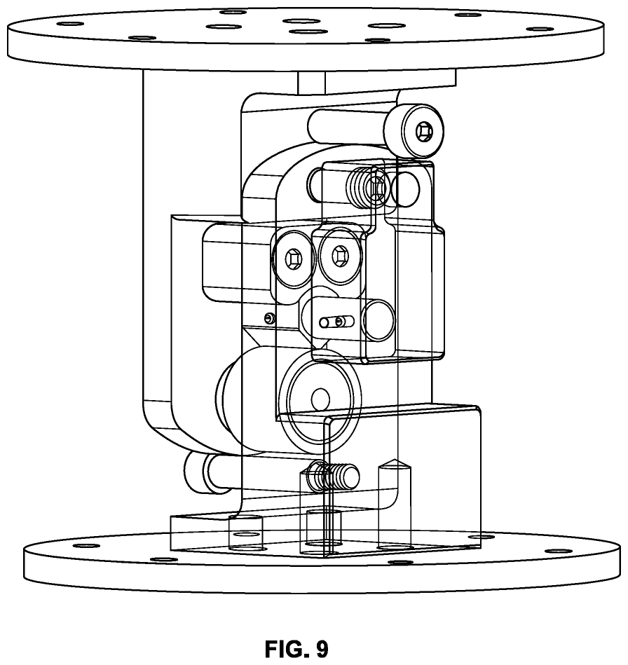

When the top and bottom portions are engaged with one another as shown in FIGS. 2 and 5-12, the second shear pin 360 and shear hub 380 are arranged such that the rounded portion 382 engages with the groove 232 of the protrusion 230 and the pointed portion 386 engages with the bearing 234. As shown, the bearing 234 may be round in order to allow the pointed portion 386 to slide around the bearing 234.

The second shear pin 360 may be configured (size shape, surface configuration, materials, etc.) in order to break under a desired amount of vertical force and may even be an “off the shelf” or commercially available shear pin. As such, the vertical failure load for the mechanical fuse may be completely tune-able and can be changed easily for a variety of applications.

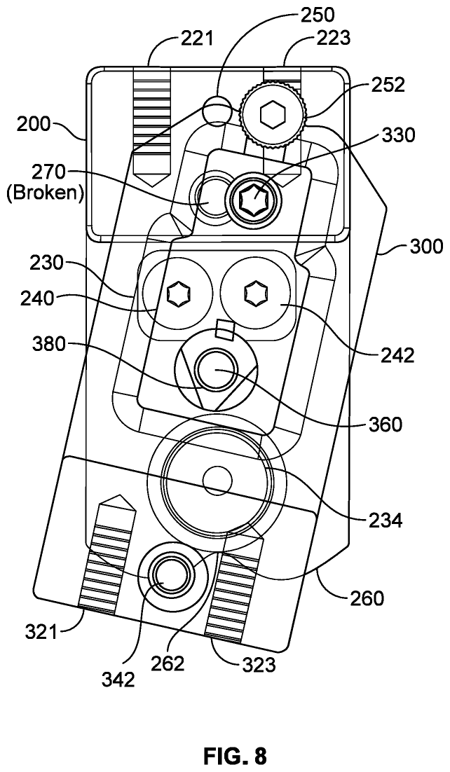

During operation, as the mechanical fuse 120 is side loaded, the bottom portion 300 may rotate relative to the top portion 200. This may cause an interior side surface of the opening 362 in the bottom portion 300 to apply a lateral (or bending) force on the first shear pin 270. At the same time, the shear hub 380 and/or the second shear pin 360 may be able to freely rotate such that the second shear pin 360 does not “feel” or experience the side loading. Once a certain side load is applied, the first shear pin 270 will break. This may cause the shear hub 380 to fall and/or to slide over the bearing 234 as depicted in FIG. 8. Eventually, the bottom portion 300 will separate from the top portion 200 causing the bottom portion 300, lifting equipment 130 (and object 140 if connected to the lifting equipment) to fall away from the moving mechanism 110. In such instances of side loading, the second shear pin 360 may not actually break when the mechanical fuse 120 breaks due to side loading.

As the mechanical fuse 120 is loaded vertically, the bottom portion 300 may be pulled downward relative to the top portion 200. This, in turn, may cause the shear hub 380 and drum 370 to pull downward on the second shear pin 360. The shear hub 380 is pulled down against the bearing which provides a resistance force against the further downward movement of the shear hub. At a certain vertical load, the combination of the downward force of the drum 370 against the second shear pin and the resistance force of the bearing 234 against the shear hub 380 may cause the second shear pin 360 to break. At this point, the vertical forces may be translated to the first shear pin 270 may break as well. This may cause the bottom portion 300 to separate from the top portion 200. This may eventually cause the bottom portion 300, lifting equipment 130 (and object 140 if connected to the lifting equipment) to fall away from the moving mechanism 110. In such instances of side loading, the second shear pin 360 may not actually break when the mechanical fuse 120 breaks due to side loading.

The mechanical fuse 120 may thus use two independent shear pins for failure in either the vertical or horizontal axis (or in both). If either pin breaks, the top and bottom portions 200 and 300 will separate entirely, leaving the bottom portion (connected to the lifting equipment 130 and, in some instances, the object 140) to fall away, ensuring the protection of the moving mechanism 110, for instance, including the crane boom and any other upstream equipment by removing the load of the lifting equipment 130 and the object 140 (if connected to the lifting equipment) from the system 100.

In some instances, the second shear pin 360 may be larger or rather, configured for greater loads, than the first shear pin 270. For example, in one configuration, the second shear pin 360 may be configured to break under 30 kilonewton loads and the first shear pin may be configured to break under 5 kilonewton loads. This may be especially useful when used for lifting and filling large, high-altitude balloons.

The mechanical fuse described herein may be utilized in various types of lifting or pulling equipment, for instance for construction, building, ballooning, or other industries which utilize cranes such as the oil and gas industries as well as heavy manufacturing. Almost all lifting cranes have a much lower side loading capacity and are not used when any side load can be imparted. This can often mean stopping work in wind or using complex rigging for non-standard shaped objects. However, this mechanical fuse may be used upstream of the lifted product to protect the crane or lifting device from any type of loading, side load and vertical load, reducing the likelihood of stopping work or complex rigging.

Most of the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A system comprising a mechanical fuse, the mechanical fuse including:
a top portion having a first shear pin configured to break when a predetermined side load is applied to the mechanical fuse; and
a bottom portion having a second shear pin, wherein the second shear pin is configured to break when a predetermined vertical load is applied to the mechanical fuse and wherein the mechanical fuse is arranged such that when the second shear pin is broken under the predetermined vertical load, the first shear pin also breaks before the bottom portion separates from the top portion, and when the first shear pin is broken under the predetermined side load, the second shear pin remains intact when the bottom portion separates from the top portion.

2. The system of claim 1, wherein the bottom portion is configured for attachment with lifting equipment.

3. The system of claim 2, further comprising the lifting equipment.

4. The system of claim 1, wherein the top portion includes a protrusion having a groove therein configured to engage with a shear hub of the bottom portion.

5. The system of claim 4, wherein the second shear pin is at least partially arranged within the shear hub.

6. The system of claim 5, wherein the shear hub is able to freely rotate around the second shear pin.

7. The system of claim 5, wherein when the bottom portion is engaged with the top portion and a side load is applied to the mechanical fuse, the side load causes the shear hub to rotate around the second shear pin.

8. The system of claim 7, wherein the bottom portion further includes a drum having an opening therein and the second shear pin is at least partially arranged within the opening of the drum.

9. The system of claim 8, wherein when a vertical load is applied to the mechanical fuse, the drum and the shear hub each impart forces on the second shear pin in different directions.

10. The system of claim 9, wherein the top portion further includes a bearing arranged below the protrusion, and when a vertical load is applied to the mechanical fuse, the bearing applies a force against the shear hub and the second shear pin.

11. The system of claim 4, wherein the top portion further includes a bearing arranged below the protrusion, and wherein when the bottom portion is engaged with the top portion, the shear hub is arranged between the protrusion and the bearing.

12. The system of claim 11, wherein the shear hub includes a rounded portion and a portion opposite the rounded portion, and wherein when the bottom portion is engaged with the top portion, the rounded portion is arranged to engage with the groove and the portion opposite of the rounded portion is arranged to engage with the bearing.

13. The system of claim 1, wherein the top portion further includes a first threaded opening and a first groove in an outer edge of the top portion, and wherein when the bottom portion is engaged with the top portion, the first groove is arranged to engage with a first bolt.

14. The system of claim 13, further comprising a first bolt and a second bolt arranged in the first threaded opening, and wherein the bottom portion further includes a second threaded opening in which the first bolt is arranged and a second groove in an outer edge of the bottom portion, and wherein when the bottom portion is engaged with the top portion, the second groove is arranged to engage with the second bolt.

15. The system of claim 14, wherein the first bolt and the second bolt are arranged to limit bending of the mechanical fuse when the bottom portion is engaged with the top portion.

16. The system of claim 1, wherein the bottom portion includes an opening configured to receive the first shear pin.

17. The system of claim 16, wherein the opening includes one or more slots in order to reduce vertical loading on the first shear pin when the bottom portion is engaged with the top portion.

18. The system of claim 1, wherein when the bottom portion is engaged with the top portion the first shear pin is arranged in an opening of the bottom portion, and a side load is applied to the mechanical fuse, a side surface of the opening causes a lateral force on the first shear pin.

19. The system of claim 1, wherein the bottom portion is configured for attachment with a crane boom of a crane.

20. The system of claim 19, further comprising the crane.
